(19) United States
(12) Patent Application Publication
(10) Pub. No.: US 2018/0186449 A1
(43) Pub. Date: Jul. 5, 2018

(54) ANNULAR LIFT FAN VTOL AIRCRAFT

(71) Applicant: Yun Jiang, Toronto (CA)

(72) Inventor: Yun Jiang, Toronto (CA)

(21) Appl. No.: 15/397,163

(22) Filed: Jan. 3, 2017

(51) Int. Cl. B64C 29/00; B64C 1/16; B64C 1/00

(52) U.S. Cl. CPC B64C 29/0025; B64C 1/0009; B64C 1/16

(57) ABSTRACT

The invention is an annular lift fan system for a VTOL type aircraft. In detail, the invention comprises an annular duct (16), a lift fan set (3), engines (6, 7), a central fuselage (1), and an outer wing (5). The lift fan set (3) is mounted in the annular duct (16) and powered by the engines (6, 7) incorporated in the outer wing (5). The annular duct is open for the lift fan set to provide high lift efficiency in VTOL and transition mode, and is closed off by shutters and louvers to provide aerodynamic lift and reduce drag in cruise mode.

### TECHNICAL FIELD

The present invention relates to vertical take-off and landing (VTOL) aircraft and, more specifically, relates to VTOL aircraft wherein annular lift fans are used to provide powered lift while in hovering mode and transition mode.

### BACKGROUND

The primary drawback to conventional fixed wing aircraft is that they must have a runway to create sufficient airflow over the wings such that they may take off and land. Much effort has been directed towards the development of aircraft capable of vertical take-off or landing which are not restricted to airport runways but can land and take-off from any relatively small open area.

There are four types of successful and practical VTOL aircraft so far. They are helicopter, vectored jet aircraft, tiltrotor, and ducted lift-fan aircraft. These aircraft provide solutions to this problem, but also have some disadvantages.

Helicopters have rotary wing capable of vertical flight and hover, but they often have relatively slow forward speeds as the rotating blades create a large aerodynamic drag. A helicopter has a limited forward speed of less than 200 Knots due to compressibility effects on the rotor blade tips when the blades rotate at the speed of sound. Furthermore, the reaction of the rotation of its main rotor requires the use of a tail rotor rotating about a horizontal axis. Loss of function of the tail rotor is generally fatal to the airworthiness of the helicopter. Helicopters achieve horizontal flight by cyclic control of the rotor blade pitch, and control ascent and descent by collectively control the blade pitch. These lead to complex rotor control systems which are difficult and costly to maintain, and which require considerable pilot training and skill. The large exposed rotor blades are also vulnerable to strikes and dangerous to persons in the vicinity of the aircraft on the ground.

Vectored jet aircraft vector the engine exhaust from one or more turbofan engines downward to create lift. Once airborne, this type of aircraft gradually transitions the thrust aft until a forward airspeed sufficient to support the aircraft is reached, at which point the aircraft is wing-borne and conventional aerodynamics may take over. Such an aircraft is exemplified by jet aircraft the AV-8A Harrier V/STOL aircraft. The Harrier utilizes a turbofan engine for both hover and cruise propulsion. The fan provides significant trust for vertical lift in hover, but its correspondingly large frontal area increases the drag of the aircraft and limits its maximum speed to just barely above supersonic speed. Also, the jet turbines must produce exhausting air at extremely high speed and pressure to develop the required amount of thrust for vertical and horizontal flight. The nozzles are designed for efficient high speed forward thrust but are very inefficient in vertical lift mode; accordingly much greater power input is required for vertical lift than would otherwise be the case. Because of the high speed and force of exhausting air, takeoff and landing pads must be specially prepared so as not to be damaged. A relatively large clearance area must be provided about the aircraft to avoid the exhaust gas overturning objects that are not secured to the ground. The gas usually also have a temperature higher than 800° F., which may cause damage to surfaces such as runways, aircraft carrier decks, and natural terrain.

The tilt rotor concept, found in the V-22 Osprey aircraft, uses large diameter propellers powered by two cross-shafted turboshaft engines. Its disc loading is higher than a helicopter, but lower than a turbofan and, thus is efficient in the vertical flight modes. However, the large propellers limit the top speed to about 300 Knots at sea level due to compressibility effects on the propeller tips. Another problem with tiltrotors involves stability control difficulties. Particularly, turbulent rotational flow on the propeller blades may occur in descent and cause a vortex-ring state. The vortex-ring state causes unsteady shifting of the flow along the blade span, and may lead to roughness and loss of aircraft control. Also, the propellers have a large diameter and may strike the landing surface when the engines are still fully forward.

The last successful known approach to VTOL aircraft is the use of lift fan or fans mounted in the airframe for developing vertical trust aligned with the aircraft center of mass. Horizontal thrust is developed either by deflecting the vertical thrust once take off has been achieved, or by operating a separate horizontal thruster. The lift fans may be gas driven or shaft driven by turbofan engines. While these aircraft often use very high disc loading fans, they are still more efficient than pure jet variants. An exemplary lift-fan aircraft is the Ryan XV-5, which was developed during the 1960s and flown successfully in 1968. The XV-5 used a pair of General Electric J-85 turbojet engines and three lift fans for controlled flight. Installed in each wing was a 62.5″ diameter fan to provide the majority of the thrust, with a smaller fan in the nose to provide some lift as well as pitch trim. For vertical liftoff, jet engine exhaust was diverted to drive the lift-fan tip turbines via a diverter valve. The core engines provided a total thrust of 5,300 pounds in forward flight mode, but could generate a total lift thrust of 16,000 pounds via the lift fans in hover mode. Using the lift fans provides a 200% increases in the total thrust, a clearly advantageous feature for vertical takeoff and landing aircraft. The recent development of this kind of aircraft is the Lockheed Martin F-35B joint strike fighter. A lift fan incorporated in fuselage is coupled to the turbofan engine by means of a drive shaft to augment the basic engine thrust for V/STOL operation. The idea was patented in U.S. Pat. No. 5,209,428 assigned to Lockheed Co. in 1993.

The ducted fans so far are all circular duct or its variants with a central inlet. The fans are submerged in the fuselage or wings. This design not only limits the size of fans due to the constraint of fuselage and wing size but also increases drag because the wings containing the fans have to be made relatively thick to maintain enough depth of fan ducts. The thick wings create unacceptable drag during forward flight. Because of the relatively small size, the circular lift fans thus far are all high disc loading in order to provide sufficient vertical thrust to raise the aircraft off the ground.

According to the momentum theory of ducted fans, high disc loading means higher power required to lift the aircraft, thus leading to low lift efficiency. To reduce the disc loading and increase lift efficiency, the fan area has to be increased. However, the space in conventional aircraft for circular lift fan is limited. Like Ryan XV-5A, the wing size is not enough to contain larger low disc loading circular fans. Other designs, such as a huge circular lift fan in the center of the aircraft or a plurality of small circular ducted fans about the central fuselage, suffer from other problems, such as difficult layout for fuselage, thick wing, and increased complexity, which make them unpractical so far.

It is therefore desirable to provide a solution that increases lift fan area and lift efficiency while keeping all the benefits of lift fan and also avoiding the drawbacks of conventional VTOL aircraft, such as slow cruise speed, dangerous exposed rotor blades, hot downward high speed and pressure exhausting air, poor stability, etc. In the present invention, this is achieved through an annular lift fan system shaft-driven or gas-driven by forward turbofan engines. Briefly, an annular lift fan system about a central fuselage is disclosed here.

There have been some disclosures with annular ducted fan in patents, but all these disclosures suffer from various problems. One problem is that the annular duct is not closed and the fan continues to work in cruise flight. The horizontal lift fan works efficiently in hover mode but introduces tremendous momentum drag in cruise mode, leading to very low forward speed. Another problem is to use multi-stage fans or compressor, which cause serious vibration in transition mode due to the strong interaction between the fans and incoming flow. The last problem is that the duct is not optimized. Usually straight or narrowing duct is disclosed. The non-optimized duct can greatly reduce the advantages of duct. All the problems are solved in the present invention.

It is a primary object of the present invention to provide an annular lift fan system for VTOL aircraft to improve lift efficiency in the takeoff, landing and transition modes with optimized configuration.

It is another primary object of the present invention to provide a design for VTOL aircraft having high efficiency in both hover and level flights.

### SUMMARY OF THE INVENTION

The present invention discloses a lift fan system for VTOL aircraft. In detail, the invention relates to aircraft comprising an annular lift fan set mounted between the central fuselage and the outer wing. The lift fan set includes one fan or two counter-rotating fans that are pneumatic or mechanic coupled in the hover mode to engines mounted in the outer wing of the aircraft. Controllable upper shutters and lower louvers are used to close off the annular duct during forward flight and to control the airflow through the duct during transition flight. The surfaces of the closed duct become part of the wing of the aircraft to provide aerodynamic lift during forward flight. The annular duct walls includes curved inlet lips, which are smoothly connected with the upper surfaces of the fuselage and the outer wing, and diffused outlet to maximize duct lift and increase lift efficiency.

Briefly, the present invention uses a large annular duct to replace conventional circular duct of lift fan system. The main differences between a traditional circular duct and the annular duct are: 1. with the fuselage in the center, the annular duct can be made much larger around the fuselage, thus the fan area and also fuselage size are greatly increased to realize low disc loading and high lift efficiency that is comparable to helicopter rotor; 2. meanwhile, the larger diameter of the annular duct does not reduce the duct effect.

Combining the annular lift fan system with forward turbofan engines provides a perfect VTOL aircraft that can fly faster, safer and high efficiently in both hover and level flight. The preliminary numerical simulations using ANSYS FLUENT demonstrate that the aircraft incorporating annular lift fan system has the figure of merit of 0.73 and lift efficiency of 4.25 kg/kw, and may fly faster than the Apache AH-64E and the Osprey V-22 based on aerodynamic drag prediction. The smooth transition from vertical take-off to cruise flight needs extra forward thrust to overcome a peak of drag (Jiang Y. CFD Study of an Annular-Ducted Fan Lift System for VTOL Aircraft. Aerospace 2015, 2(4): 555-580).

The novel features which are believed to be characteristic of the invention, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### DESCRIPTION OF THE DRAWINGS

FIG. 1 illustrates a top view of an annular lift fan aircraft with the duct opened (shutters and louvers not shown).

FIG. 2 illustrates a cross sectioned view of plane “2-2” of FIG. 1.

FIG. 3 illustrates a top view of an annular lift fan aircraft with inner fan and outer fan.

FIG. 4 illustrates a cross sectioned view of plane “17-17” of FIG. 2.

FIG. 5 illustrates a perspective view of an annular lift fan aircraft of rhombic shaped outer wing with the duct closed off by shutters.

### DETAILED DESCRIPTION

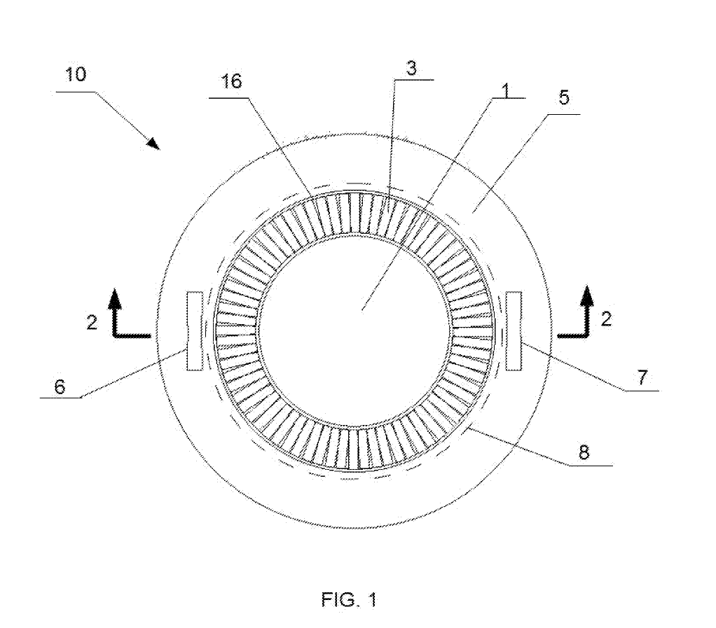

The invention relates to aircraft with annular lift fan system capable of efficient vertical takeoff and landing and horizontal flight. Referring now to the figures, and more particularly to FIG. 1, aircraft according to a first embodiment of the present invention is designated in its entirety by reference number 10. The aircraft 10 has a central fuselage 1, an annular duct 16 in which a lift fan set 3 is mounted, an outer wing 5, and two turbofan forward engines 6, 7 to propel the aircraft in cruise flight. The forward engines can be one, two or more, and can be any type of engines used in the aerospace industry, such as turbojet engine, turbopropeller engine, turboshaft engine, piston engine, electric motor, without departing from the scope of the present invention. The lift fan set 3 can be pneumatically (gas-driven), mechanically (shaft-driven), or electrically (motor-driven) coupled with the engines 6, 7 in VTOL. For gas-driven mode, a rectangular-shaped gas chamber 8 is also shown. The annular duct is completely opened with the shutters and louvers removed. Although the aircraft 10 may have other sizes without departing from the scope of the present invention, in one embodiment the aircraft has an outer wing diameter of 18 meters, annular duct diameters of 10 and 14 meters, fan blade length of 2 meters, and depth of duct of 1 meter, in order to compare with the rotor diameter 14 meters of the Boeing AH-64E Apache helicopter. The weight of the aircraft 10 is 10.433 tons. The lift fan area is 75.36 m², much larger than conventional circular fans. The area of fuselage is 78.5 m², also much larger than that of conventional helicopters.

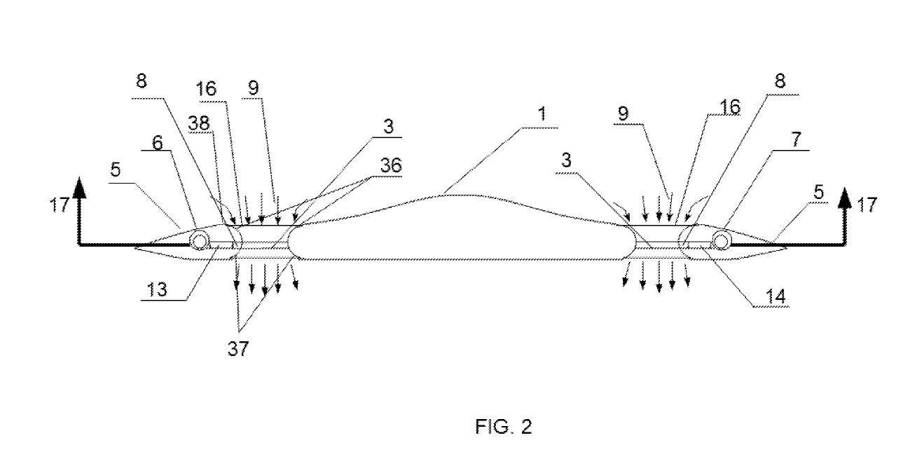

The lift fan set can have one fan or two counter-rotating fans. FIG. 2 shows one fan 3. For gas-driven mode, the fan 3 is powered by exhaust gases from two turbofan engines 6, 7 respectively through gas ducts 13, 14 to tip turbines in the rectangular-shaped gas chambers 8. The number of fan blades can range from 16 to 64, preferred 32. One fan must have airflow deflector or stator (not shown) in the annular duct to eliminate torque. The walls of the annular duct with curved inlet lips 36 and diffused outlet 37 are optimized to the walls with cross section of arc or half circle. The tips of fan blades must touch the duct wall with no clearance gap to eliminate blade tip loss, or the fan tips become part of the half circular duct wall. With this optimized configuration, the figure of merit of 0.772 and the power loading of 5.51 Kg/kw are achieved without ground effect, very close to the theoretical limit. When the distance from the aircraft to the ground is 10 m, the figure of merit reaches 0.822 with the power loading of 5.87 kg/kw (9.65 lbs/hp)(Jiang Y. CFD study of a new annular lift fan configuration with high lift efficiency).

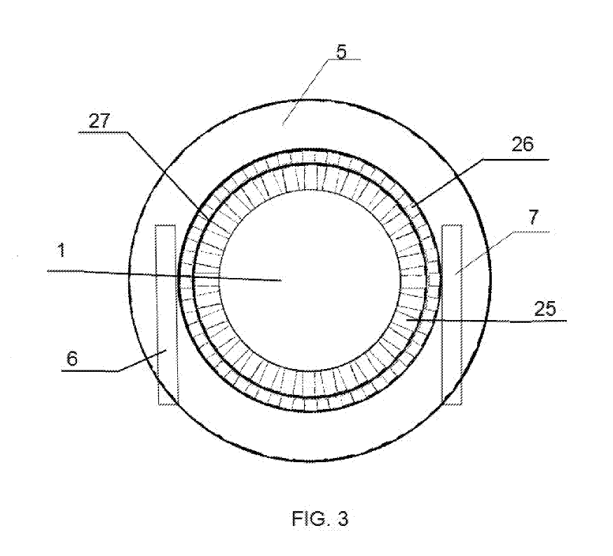

Although the lift fan set has one fan here in the present embodiment, it can also have two single-stage fans horizontally placed with inner and outer fans as shown in FIG. 3, without departing from the scope of the present invention. In FIG. 3, besides the central fuselage 1 and outer wing 5, the annular lift fan set has an inner fan 25, outer fan 26, and ring baffle 27. The inner fan 25 and outer fan 26 are coupled by the gears in the ring baffle 27 to counter rotate at almost the same speed to eliminate torque. The tips of the outer fan 26 touch the outer wall of the annular duct and are tip-driven by the forward engines 6, 7 in the outer wing.

The single-stage fans are emphasized here because we found multi-stage fans may cause serious vibration during transition flight due to the strong interaction between the multi-stage fans in the incoming flow (Jiang, Y; Zhang, B. Numerical study of transition of an annular lift fan aircraft. Aerospace 2016, 3, 30).

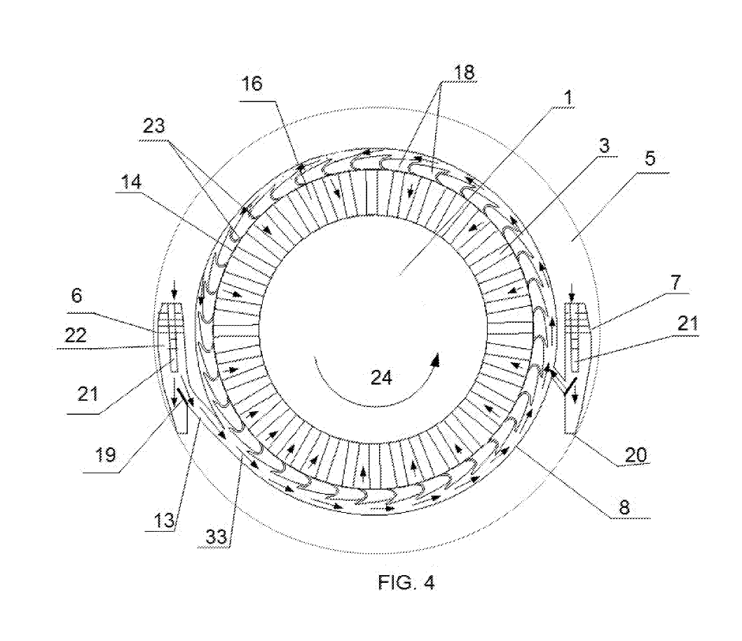

FIG. 4 illustrates pneumatic coupled tip turbine for gas-driven mode. Exhaust from engine core 21 and bypass duct 22 of turbofan engines 6 and 7 is diverted by an internal gate or valve 19 to gas duct 13 and gas chamber 8. The exhaust gases 33 flow along the rectangular-shaped gas chamber 8 in a counterclockwise direction and exit from the discharge ports 23 to the annular fan duct 16. The discharge ports 23 are disposed between the turbine blades 18 on the inner wall 14 of the chamber 8. The inner wall 14 is fixed to and rotates with the fan blades 3 and their tip turbine blades 18. The airflow 33 causes pressure difference on the two surfaces of the tip turbine blades 18 and pushes the turbine and fan to rotate in a counterclockwise direction 24. The tip turbine and gas chamber can also be other types, such as disclosed in U.S. Pat. No. 5,275,356, without departing from the scope of the present invention.

The lift fan system can also be shaft-driven, which can be found in detail in U.S. Pat. No. 7,267,300. For shaft-driven mode, the turbofan engines need to be modified to be convertible between turboshaft mode and turbofan mode of operation. The details of convertible engines can be found in U.S. Pat. Nos. 4,791,783 and 5,209,428.

Referring particularly to FIGS. 2 and 4, in vertical takeoff mode, exhaust gases from engines 6, 7 are completely diverted by internal valve 19 to gas ducts 13, 14 to drive fans 3 to rotate. The rotation of the fans induces airflow 9 sucked from above of the inlet of the annular duct 16 to exit from the round diffused outlet 37. The air is pushed downward by the fans and the duct to generate upward thrust, which lifts the aircraft off the ground.

According to the numerical simulation results, more than half of the total thrust comes from duct thrust, by the low pressure induced by the airflow on the inlet lips 36 and upper surface of outer wing 38. Among the duct thrust, about half comes from the inlet lips 36 and the other half from the outer wing 38.

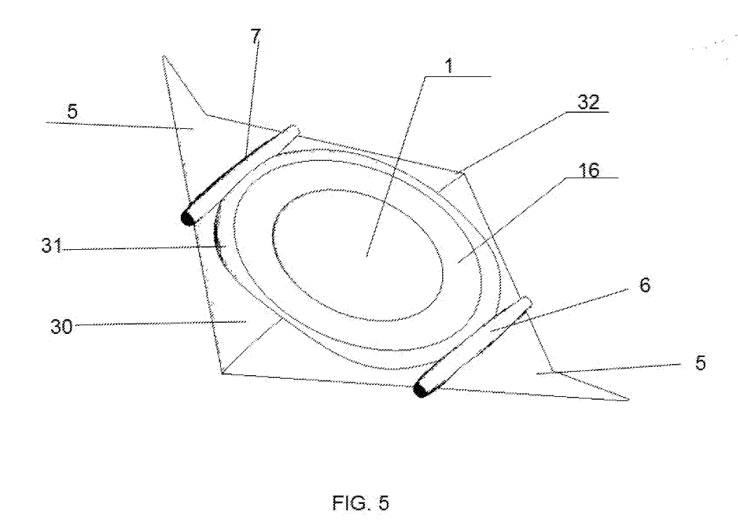

In cruise flight, the annular duct must be closed by shutters (16, FIG. 5) and louvers. The closed surfaces become part of wing to provide aerodynamic lift. The lift fan system does not work in cruise mode so that the rotor drag is eliminated. The numerical predictions of aerodynamic drag show the aircraft can reach the maximum speed of 428 km/h, 46% faster than the Apache, with the same power of the Apache.

Without the limits of rotor drag, the speed of the aircraft can increase further if higher thrust turbofan engines are equipped. To reach the speed of 0.7 Ma (857 km/h), the aircraft will need jet thrust of 72.3 kN.

The outer wing 5 can be any shapes, such as circular, rhombic, triangular, etc., without departing from the scope of the invention. FIG. 1 shows a circular shaped outer wing. FIG. 5 shows a rhombic shaped outer wing. The aircraft has a central fuselage 1, an annular duct closed by shutters 16, an rhombic outer wing 5 including a forward end 30 and an aft end 32, two turbofan engines 6, 7, and a conjunctive part 31 joining the annular duct 16 with the outer wing 5. The aircraft can also have traditional steering components such as ailerons, flaps, elevators, spoiler, slats, stabilizers, and a rudder, etc. (not shown).

The attitude control can be performed through changing the direction of the thrust from the two jet engines respectively. The thrust vectoring can also be used to eliminate the nose up pitching moment and provide part of lift during transition.

While the invention has been described with reference to particular embodiments, it should be understood that the embodiments is merely illustrative as there are numerous variations and modifications which may be made by those skilled in the art. Thus, the invention is to be construed as being limited only by the spirit and scope of the appended claims.

I claim:

1. A VTOL aircraft with an annular lift fan system comprising:
an annular duct with the duct walls of cross section of arc or half circle;
an annular lift fan set;
a central fuselage;
an outer wing;
forward engines to propel the aircraft in cruise flight;
and means for pneumatic or mechanic coupling of said lift fan set and said engines.

2. The aircraft as set forth in claim 1 wherein said annular lift fan set can include two horizontally positioned counter-rotating single-stage fans or one fan with airflow deflector or stator in said annular duct.

3. The aircraft as set forth in claim 1 wherein the number of said fan blades ranges from 16 to 64.

4. The aircraft as set forth in claim 1 wherein the tips of fan blades must touch the duct wall with no clearance gap, or the fan tips become part of the half circular duct wall.

5. The aircraft as set forth in claim 1 wherein said outer wing can be any configurations, for example, circular or rhombic.

6. The aircraft as set forth in claim 1 wherein said forward engines can be one, two, or more, and can be any type of engines used in aerospace industry such as turbofan engine, turbojet engine, turbopropeller engine, turboshaft engine, piston engine, electric motor.

7. The aircraft as set forth in claim 1 wherein said annular duct is closed by shutters and louvers during forward flight to generate aerodynamic lift and reduce drag.

8. An annular lift fan system comprising:
an annular duct with the duct walls of cross section of arc or half circle;
an annular lift fan set;
a central cabin;
and engines.

9. The system as set forth in claim 8 wherein said annular lift fan set can include two horizontally placed counter-rotating single-stage fans or one single-stage fan with airflow deflector or stator in said annular duct.

10. The system as set forth in claim 8 wherein the number of said fan blades ranges from 16 to 64.

11. The system as set forth in claim 8 wherein the tips of fan blades must touch the duct wall with no clearance gap, or the fan tips become part of the half circular duct wall.

12. The system as set forth in claim 8 wherein said engines can be one, two, or more, and any types, such as turbofan engine, turbojet engine, turbopropeller engine, turboshaft engine, piston engine, electric motor.
